(19) United States
(12) Patent Application Publication
(10) Pub. No.: US 2011/0170387 A1
(43) Pub. Date: Jul. 14, 2011

(54) OPTICAL DISC APPARATUS AND CONTROL METHOD IN THE SAME

(76) Inventors: Cheol JIN, Seoul (KR); Donghyeong SEONG, Seoul (KR)

(21) Appl. No.: 12/987,412

(22) Filed: Jan. 10, 2011

(30) Foreign Application Priority Data
Jan. 11, 2010 (KR) 10-2010-0002096

(51) Int. Cl. G11B 7/00

(52) U.S. Cl. 369/44.26; 369/44.34; 369/44.27; G9B/7

(57) ABSTRACT

An optical disc apparatus and a control method for the optical disc apparatus are provided. A control method for an optical disc apparatus according to one embodiment of the present invention may comprise rotating a disc through a spindle motor if a type of a disc loaded in the optical disc apparatus is determined; and carrying out servo operation which can be processed irrespective of rotation speed of the disc while checking whether the rotation speed of the disc equals a predetermined speed. Servo operation which can be processed independently of the rotation speed of the disc can correspond to operation related to focusing servo and additionally to operation related to tracking servo. Therefore, since the time the user has to wait for requested video, music, or data to be extracted after the user has inserted a medium is reduced, user convenience can be improved.

### BACKGROUND

1. Field

This document relates to an optical disc apparatus and a control method for the optical disc apparatus. More specifically, the present invention relates to a method for minimizing initial recognition time for a disc.

2. Related Art

If a disc is inserted to an optical disc apparatus or power is applied again to the optical disc apparatus when a disc is already loaded therein, the disc apparatus first determines a type and size (8 cm or 12 cm) of the disc. The disc apparatus then checks the contents recorded in the disc by accessing a lead-in area of the disc and outputs the contents through a display window prepared in the apparatus. Alternately, the disc apparatus transfers the checked contents to a host through an interface connected to the host and an application of the host displays the transferred contents. Next, the optical disc apparatus, according to the user's request, performs operation of reproducing data recorded in the disc or recording data in the disc.

To check the contents recorded in a disc, the optical disc apparatus drives a spindle motor which rotates the disc and makes rotation speed of the disc equal an RPM specified for the inserted disc. The optical disc apparatus then carries out focusing servo and tracking servo by driving an actuator; and reads out required data from the lead-in area.

It takes one or more seconds for a disc to reach a predetermined RPM from the moment the disc starts rotation. The optical disc apparatus performs no particular operation but waits until the disc reaches the predetermined RPM. Due to this reason, it takes considerable time before the optical disc apparatus actually plays back the disc.

### DISCLOSURE

### Technical Problem

The present invention has been made in an effort to provide a method for reducing initial operation time required for recording or reproducing a disc.

### Technical Solution

A control method of an optical disc apparatus according to one embodiment of the present invention comprises rotating a disc through a spindle motor if a type of a disc loaded in an optical disc apparatus is determined; and carrying out servo operation which can be processed irrespective of rotation speed of the disc while checking whether the rotation speed of the disc equals a predetermined speed.

An optical disc apparatus according to another embodiment of the present invention comprises an optical pick-up for recording or reading out data in or from a disc; a spindle motor for rotating the disc; a recording/reproducing unit for driving the optical pick-up and the spindle motor and processing a servo signal and record/playback data; and a controller configured to determine a type of a loaded disc, rotate the disc through the spindle motor, and control the recording/reproducing unit to carry out servo operation which can be processed irrespective of rotation speed of the disc while checking the rotation speed of the disc equals a predetermined speed.

In one embodiment, the servo operation can comprise operation related to focusing servo. The operation related to the focusing servo can comprise adjusting the level of a focusing error signal and turning on the focusing servo. The operation related to the focusing servo can further comprise operation of adjusting a focusing offset.

In the embodiment above, the servo operation can further comprise operation related to tracking servo after the focusing servo is turned on. The operation related to the tracking servo can comprise adjusting the level of a tracking error signal and turning on the tracking servo. The operation related to the tracking servo can further comprise operation of adjusting a tracking offset.

In one embodiment, the carrying out can further comprise determining whether a disc is an 8 cm disc or a 12 cm disc based on the checked rotation speed of the disc.

In one embodiment, the method can further comprise carrying out servo operation required for reading disc-related information from the disc if the rotation speed of the disc reaches the predetermined speed, subsequent to the servo operation carried out before the predetermined speed is reached.

In one embodiment, the predetermined speed is determined by the determined type of the disc.

### Advantageous Effects

Therefore, since the time the user has to wait for requested video, music, or data to be extracted since the user has inserted a medium is reduced, user convenience can be improved.

### BRIEF DESCRIPTION OF THE DRAWINGS

The implementation of this document will be described in detail with reference to the following drawings in which like numerals refer to like elements.

FIG. 1 illustrates driving signals detected during conventional initial disc operation;

FIG. 2 illustrates one embodiment of a structure of a disc apparatus to which the present invention is applied; and

FIG. 3 illustrates driving signals detected when the initial disc operation is carried out according to the present invention.

### DETAILED DESCRIPTION

In the following, embodiments of an optical disc apparatus and a control method for the optical disc apparatus will be described in detail with reference to appended drawings.

The following describes the initial operation carried out before reproducing data from a disc or recording data to the disc in an optical disc apparatus.

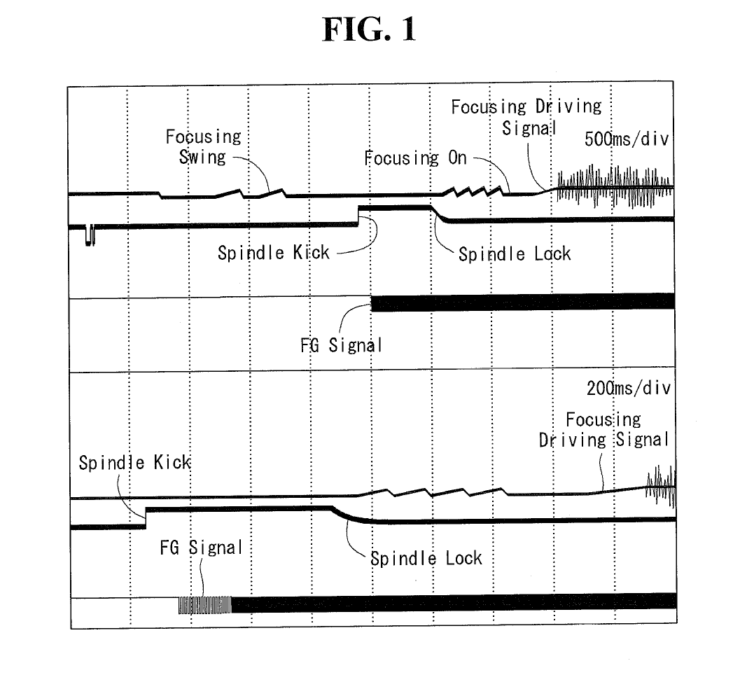

FIG. 1 illustrates driving signals detected during conventional initial disc operation.

First, if a disc is inserted to an optical disc apparatus or power is applied once again to the optical disc apparatus when a disc is already loaded therein, the optical disc apparatus turns on a laser diode for BD, a laser diode or DVD, and if necessary, a laser diode for CD sequentially. The optical disc apparatus then applies focus swing to an actuator supporting an object lens toward a disc (focusing direction) and detects a focusing error signal of an S-curve. The optical disc apparatus, based on the detected focusing error signal, determines which type (CD, DVD, or BD) the loaded disc corresponds to. The optical disc apparatus, by detecting the magnitude of the S-curve, can further determine whether the disc corresponds to a read-only disc, a write-once disc, or a rewritable disc.

Next, the optical disc apparatus starts to rotate a disc by driving a spindle motor (spindle kick), making the disc rotate at a predetermined RPM (spindle lock). The rotation speed of a disc can be detected through an FG (Frequency Generating) signal generated at the spindle motor, by which it can be checked whether the disc rotates at the predetermined RPM.

During such process, the optical disc apparatus can check whether a disc is an 8 cm disc or a 12 cm disc based on the magnitude of a current applied to the spindle motor, rotation speed of the disc, elapsed time, and so on. In other words, if rotation speed of a disc reaches a predetermined RPM quickly even with a small amount of current applied to the disc, the disc can then be determined to be small.

Next, the optical disc apparatus drives an optical system corresponding to a determined disc type and starts to extract the contents of the disc recorded in a lead-in area thereof. The optical disc apparatus turns on a laser diode corresponding to the determined disc; detects a focusing error signal; and carries out focusing servo based on the detected focusing error signal while moving the object lens toward the disc (focusing direction) by driving an actuator. If the focusing servo is turned on (focusing on), the optical disc apparatus carries out tracking servo based on a detected tracking error signal. The optical disc apparatus carries out the operation of adjusting a signal level and offset where magnitude and/or offset of the focusing error signal and the tracking error signal are adjusted.

Next, the optical disc apparatus reads out disc-related information from the lead-in area of a disc by controlling rotation of the disc with a constant angular velocity (CAV) mode or a constant linear velocity (CLV) mode. A series of operations described above comprises the initial disc operation.

While in the initial disc operation, one or more seconds are required from rotating a disc by using a spindle motor until the disc reaches a predetermined RPM, i.e., from spindle kick to spindle lock. During the time period from spindle kick to spindle lock, the optical disc apparatus carries out no particular operation but waits while performing a routine which checks if a disc rotates at a predetermined RPM by checking the FG signal. After the spindle lock, the optical disc apparatus carries out the servo adjusting operations such as the focusing servo and the tracking servo.

Therefore, in the present invention, the optical disc apparatus carries out part of the initial disc operation sequentially to reduce the time required to perform the initial disc operation as rotation speed of a disc increases from the spindle kick state until the disc enters the spindle lock state. For example, the optical disc apparatus can carry out a series of focusing servo operations including adjusting a level and an offset of a focusing error signal; and turning on the focusing servo. If the spindle lock is not achieved although the focusing servo has been turned on, the optical disc apparatus can further carry out servo operation related to the tracking servo.

The part of the initial disc operation to be carried out after the spindle kick can be processed irrespective of rotation speed of a disc, which is required to detect disc-related information recorded in the lead-in area of the disc and can be related mainly to the focusing servo and the tracking servo.

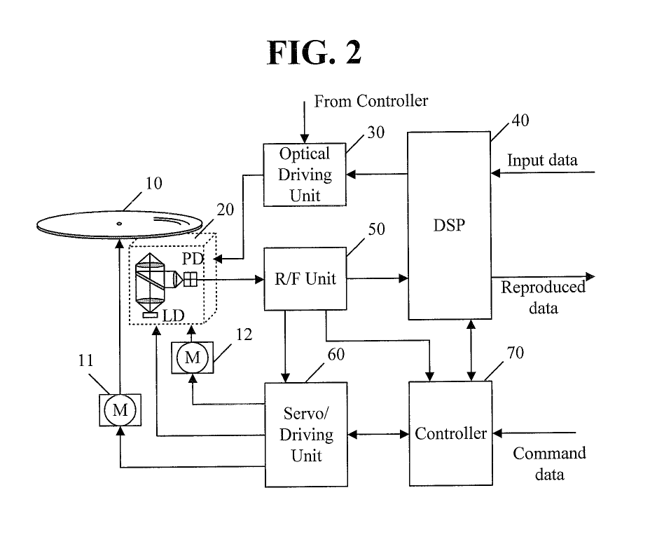

A control method according to the present invention can be applied to various types of disc apparatus capable of reproducing or recording CD, DVD, and BD disc; FIG. 2 illustrates one embodiment of a structure of a disc apparatus to which the present invention is applied.

An optical disc apparatus according to the present invention comprises a spindle motor 11; a sled motor 12; an optical pick-up 20 for recording and reading out data in and from an optical disc by using a laser beam; a recording/playback unit for driving the spindle motor 11, the sled motor 12, and the optical pick-up 20 and processing a servo signal and recording/playback data; and a controller 70 for controlling the recording/playback unit. The recording/playback unit may comprise an optical driving unit 30, a digital signal processor (DSP) 40, an R/F unit 50, and a servo/driving unit 60, where the optical driving unit 30 can be included in the optical pick-up 20 or the DSP 40.

The DSP 40 converts input digital data into a recording format by adding an error correction code (ECC); an optical driving unit 30 outputs a light quantity driving signal according to an input signal; the optical pick-up 20 records data in an optical disc 10 or reads data from a recording surface of the optical disc 10 according to the light quantity driving signal.

The R/F unit 50 outputs the signal detected at the optical pick-up 20 as a binary signal by filtering and shaping the detected signal; and also generates and outputs a tracking error signal TE, a focusing error signal FE, an RF signal, and so on. The DSP 40, by using a built-in clock synchronized with the binary signal, restores the binary signal to the original data. The servo/driving unit 60 generates a servo signal required for focusing servo, tracking servo, sled servo, and spindle servo based on the signal from the R/F unit 50; drives the spindle motor 11 which rotates the optical disc 10; drives the sled motor 12 which moves the optical pick-up 20 toward the inner and outer circumference of the optical disc 10; and drives a current required for focusing servo and tracking servo of an object lens within the optical pick-up 20 to an actuator supporting the object lens.

The controller 70 records or reads out data in and from an optical disc by controlling individual elements; to read out data from the optical disc 10 by controlling the optical driving unit 30, drives a laser diode within the optical pick-up 20 by using playback power; and to record data to the optical disc 10, drives the laser diode by recording power.

In addition, the controller 70, based on an RF signal detected at the optical pick-up 20 and output from the R/F unit 50 and a FG signal generated from the spindle motor 11, controls the servo/driving unit 60 and drives the spindle motor 11, thereby rotating the optical disc 10 with a speed required, moves the optical pick-up 20 to a required position by driving the sled motor 12, and performs focusing servo and tracking servo by applying a current to the actuator supporting the object lens within the optical pick-up 20.

In what follows, a process of an optical disc's performing the initial disc operation according to the present invention is described.

The controller 70, if power is applied to the optical disc apparatus or an optical disc is inserted, turns on a laser diode within the optical pick-up 20 by controlling the optical driving unit 30; provides power to a focusing actuator included in the optical pick-up 20 by controlling the servo/driving unit 60, thus moving an object lens in a focusing direction to come close to or get away from the disc (focusing swing). The optical disc apparatus determines a type of the disc based on a focusing error signal output from the R/F unit 50. To be more specific, the optical disc apparatus turns on laser diodes for BD, DVD, or CD sequentially and detects a focusing error signal by making the object lens to swing. Based on the detection time and the level of the S-curve, the optical disc apparatus can determine which type (CD, DVD, or BD) the disc corresponds to and also determine whether the disc corresponds to a read-only disc, a write-once disc, or a rewritable disc.

Next, the controller 70, while increasing rotation speed of a disc by controlling the servo/driving unit 60 and applying power to the spindle motor 11 (spindle kick), based on an FG signal output from the spindle motor 11, checks whether the rotation speed of the disc has reached a RPM specified for the determined disc type.

The controller 70, based on the magnitude of power applied to the spindle motor 11 checked through the servo/driving unit 60 and the rotation speed of the disc detected through the FG signal, can determine whether the disc inserted corresponds to an 8 cm-diameter disc or a 12 cm-diameter disc.

After the spindle kick, the controller 70 turns on a laser diode corresponding to the determined disc type by controlling the optical driving unit 30 and carries out focusing servo operation by controlling the servo/driving unit 60 while checking through the FG signal whether the rotation speed of the disc equals the predetermined RPM. To be more specific, the controller 70 provides power to a focusing actuator included in the optical pick-up 20 and makes the actuator to swing so that the object lens moves in a focusing direction. And the controller 70 measures the magnitude of an S-curve detected through the R/F unit 50 as the laser beam emitted from the object lens is focused on around a recording layer of the inserted disc and adjusts the magnitude of the S-curve to a level suitable for carrying out a servo. The focusing servo is made to be turned on (focusing on) by closing a focusing servo loop when the focusing error signal becomes zero at the center of the S-curve.

The controller 70 can further adjust a focusing offset by controlling the servo/driving unit 60 before the focusing servo is turned on by taking account of the degree of symmetry of the S-curve, a sum signal of the photo detector, a checking result of whether the focusing error signal equals zero, and the like. The focusing offset can be further adjusted even after the tracking servo has been turned on.

The controller 70 checks the magnitude, the degree of symmetry, and eccentricity of the tracking error signal detected through the R/F unit 50 after the focusing servo has been turned on; adjusts the level and the offset of the tracking error signal in association with tracking servo; and turns on the tracking servo by closing a tracking servo loop when the tracking error signal becomes zero while the laser beam focused on the recording layer crosses over a track.

Since the focusing servo operations related to focusing-on and focusing adjustment; and the tracking servo operations related to tracking-on and tracking adjustment can be carried out independently of the rotation speed of a disc, the focusing and the tracking servo operation can be performed separately from achieving the spindle lock after the spindle kick.

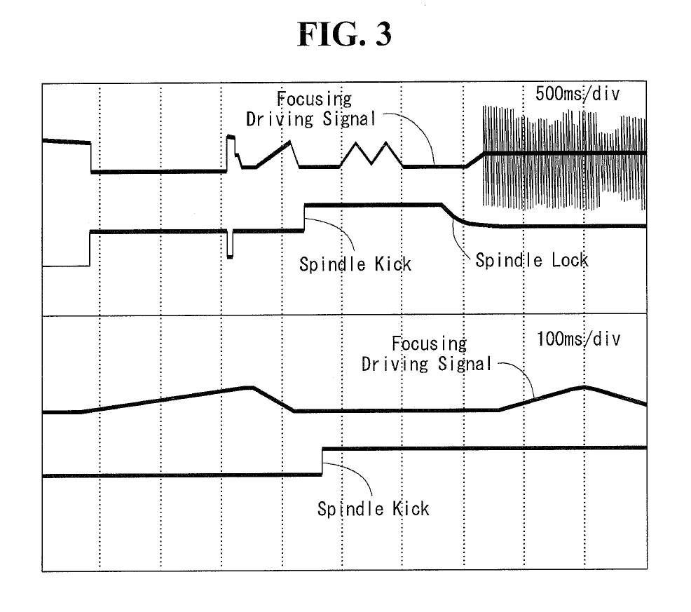

FIG. 3 illustrates driving signals detected when the initial disc operation is carried out according to the present invention. The upper figure of FIG. 3 illustrates the individual driving signals with a time scale of 500 ms units while the lower figure of FIG. 3 is a magnified view of the upper figure with a time scale of 100 ms. FIG. 3 illustrates that focusing swing for the focusing servo is performed while the spindle lock is secured after the spindle kick and the focusing servo is turned on when the spindle lock is established.

The exemplary embodiments of the present invention described above have been introduced for illustrative purposes only. It should be understood that those skilled in the art would be able to improve, modify, substitute, or add various other embodiments within the technical principles and scope of the present invention as defined by the following appended claims.

What is claimed is:

1. A control method for an optical disc apparatus, comprising:
rotating a disc through a spindle motor if a type of a disc loaded in an optical disc apparatus is determined; and
carrying out servo operation which can be processed irrespective of rotation speed of the disc while checking whether the rotation speed of the disc equals a predetermined speed.

2. The method of claim 1, wherein the servo operation comprises operation related to focusing servo.

3. The method of claim 2, wherein the operation related to the focusing servo comprises adjusting a level of a focusing error signal and turning on the focusing servo and further comprises operation of adjusting a focusing offset.

4. The method of claim 2, wherein the servo operation further comprises operation related to tracking servo after focusing servo is turned on.

5. The method of claim 4, wherein the operation related to the tracking servo comprises adjusting a level of a tracking error signal and turning on the tracking servo and further comprises operation of adjusting a tracking offset.

6. The method of claim 1, wherein the carrying out further comprises determining whether a disc is an 8 cm disc or a 12 cm disc based on the checked rotation speed of the disc.

7. The method of claim 1, further comprising carrying out servo operation required for reading disc-related information from the disc if the rotation speed of the disc reaches the predetermined speed, subsequent to the servo operation carried out before the predetermined speed is reached.

8. The method of claim 1, wherein the predetermined speed is determined by the determined type of the disc.

9. An optical disc apparatus, comprising:
an optical pick-up for recording or reading out data in or from a disc;
a spindle motor for rotating the disc;
a recording/reproducing unit for driving the optical pick-up and the spindle motor and processing a servo signal and record/playback data; and
a controller configured to determine a type of a loaded disc, rotate the disc through the spindle motor, and control the recording/reproducing unit to carry out servo operation which can be processed irrespective of rotation speed of the disc while checking the rotation speed of the disc equals a predetermined speed.

10. The apparatus of claim 9, wherein the controller, while checking whether the rotation speed of the disc equals the predetermined speed, carries out operation related to focusing servo by controlling the recording/reproducing unit.

11. The apparatus of claim 10, wherein the operation related to the focusing servo comprises adjusting a level of a focusing error signal and turning on the focusing servo and further comprises operation of adjusting a focusing offset.

12. The apparatus of claim 10, wherein the controller, while checking whether the rotation speed of the disc equals the predetermined speed, further carries out operation related to tracking servo after focusing servo is turned on by controlling the recording/reproducing unit.

13. The apparatus of claim 9, wherein the controller, based on a signal generated by the spindle motor, checks the rotation speed of the disc.

14. The apparatus of claim 9, wherein the controller determines whether the disc is an 8 cm disc or a 12 cm disc based on the checked rotation speed of the disc.

15. The apparatus of claim 9, wherein the controller carries out servo operation required for reading disc-related information from the disc by controlling the recording/reproducing unit if the rotation speed of the disc reaches the predetermined speed, subsequent to the servo operation carried out before the predetermined speed is reached.
